(19) United States
(12) Patent Application Publication
(10) Pub. No.: US 2012/0287669 A1
(43) Pub. Date: Nov. 15, 2012

(54) BACKLIGHT, AND DISPLAY HAVING A BACKLIGHT

(75) Inventors: David James Montgomery, Oxford (GB); Stefan Rohrmoser, Oxford (GB); James Rowland Suckling, Oxford (GB); Alexander Zawadzki, Oxford (GB); Sarah Anne Mitchell, Oxford (GB)

(73) Assignee: SHARP KABUSHIKI KAISHA, Osaka (JP)

(21) Appl. No.: 13/521,286

(22) PCT Filed: Jan. 12, 2011
(86) PCT No.: PCT/JP11/50790

§ 371 Date: Jul. 10, 2012

(30) Foreign Application Priority Data
Jan. 13, 2010 (GB) 1000470.3

(51) Int. Cl. G09F 13/04

(52) U.S. Cl. 362/602

(57) ABSTRACT

A display backlight comprises a light guide plate (12b) and independent controllable light sources (10, 11). The plate (12b) is divided into first and second regions (13, 14) having light extraction features, such as corrugations, which direct light travelling in first and second directions, respectively, through the plate out of its front major surface and transmit light travelling in the second and first directions, respectively.

### TECHNICAL FIELD

The present invention relates to a backlight and to a display including such a backlight. The backlight may comprise a thin edge lit backlight that allows for 2 dimensional brightness control. The local control properties may concern a set of sub-divisions integral to a light guide plate (LGP) that is part of the backlight. Light emission control of blocks of light sources arranged on the sides of the LGP may facilitate the illumination control in the plane of the LGP. Said backlight could, for example, be used in conjunction with a liquid crystal display (LCD) for contrast enhancement, energy efficiency or to facilitate thin light weight LCD systems.

### BACKGROUND ART

A typical LCD together with a backlight with local control is shown in FIG. 1. This consists of a reflective sheet 1 on which an array of light sources 2 is placed to illuminate the back of the LCD panel 5. The reflective sheet 1 recycles light that is not directed towards the LCD panel 5. On top of the light sources 2 is a diffusive optical sheet 3 that redistributes the light coming from the light sources 2. Above the diffusive sheet 3 an assembly of further optical sheets 4 is arranged that modify the intensity and the polarization of the light coming from the light sources 2.

Local control in an LCD system similar to the one shown in FIG. 1 is achieved by controlling the brightness of individual light sources 2. However such direct lit systems are limited in their depth dimension. Furthermore the number of optical sheets needed in such systems poses a restriction for the system's weight.

A second type of LCD backlight with local control is shown in FIG. 2. This backlight consists of a single piece LGP 7. Light is emitted from light sources 6 that are mounted on rails 8 around the edges of the LGP 7. The light sources are arranged in larger blocks 9a along the long edges of the LGP 7 and in smaller blocks 9b along the LGP's short edges. The light source blocks 9a, b emit light into the LGP. This light travels essentially along a direction perpendicular to the respective light rail 8 and confined by the faces of the LGP 7. The respective column and row shaped areas of the LGP 7 along which the light from a single block of light sources is propagating are shown by dotted lines in FIG. 2a. In FIG. 2b a diagram is shown that explains the functioning of the local control mechanism of the backlight from FIG. 2a. The schematic in FIG. 2b shows the blocks of light sources as normalised values, for their respective light output. In a similar way the light output from each of the nine areas that are created by the light propagation rows and columns is given. The maximum light output of any area of the LGP will be obtained when all four blocks of light sources that contribute to the light output of the respective area emit the maximum amount of light. In the same way the light output of any area of the LGP can be reduced if the light output of any of the contributing blocks of light sources is reduced.

Local control in a backlight similar to that shown in FIG. 2 can be achieved by controlling the brightness of individual blocks of light sources. Switching off one block of light sources will decrease the brightness of the corresponding row or column area of the LGP by one quarter. Switching off additional blocks of light sources increases the dimming in a similar way. In systems like this decreasing the brightness of a certain area of the LGP incurs a decrease of brightness in other areas of the LGP as well. This sets a fundamental limit to the dimming ratios achievable.

EP1906218A1 (published 2 Apr. 2008) proposes an LGP with grooves arrayed on its top and bottom surfaces. The grooves on the top surface are aligned parallel to the light propagation direction. On the bottom surface there are two sets of perpendicular grooves that are interlaced. One set is perpendicular to the propagation direction of the light whereas the other set of grooves is perpendicular to the orientation direction of the light. The intersecting sets of grooves allows to create extraction regions while at the same time maintain good uniformity of the light distribution within the LGP.

EP1016817A1 (published 5 Jul. 2000) and U.S. Pat. No. 6,773,126B1 (published 10 Aug. 2004) propose a thin uniform backlight based on the principle of total internal reflection. Said backlight comprises one thin LGP on one of whose major surfaces is arranged a pattern of diffractive structures. The diffractive structures are arranged in pixel like sub-structures each of which possesses a certain orientation of the diffractive structures. By appropriate arrangement of perpendicular and parallel oriented sub-structures uniform light extraction from the LGP can be obtained. The particular arrangement of said sub-structures is only governed by the aim to achieve efficient and uniform extraction. For this reason this backlight structure is unsuitable to achieve local control.

U.S. Pat. No. 6,144,480 (published 7 Nov. 2000) proposes an LGP that is used to modify the amplitude or phase of an optical wave. This modification is performed by grating structures on the back face of the LGP. In one embodiment of this prior art these grating structures are arranged into sub-areas each of which features perpendicular grating orientations to the adjacent sub-areas. The grating structures are defined by their pitch and the geometrical groove parameters of height and apex angle. These parameters are adjusted to achieve the desired modification of the optical wave's phase and amplitude. The described device needs light sources capable of emitting coherent light to function. The change of phase and amplitude of the optical wave is caused by the specific parameters of the grating parameters rather than by controlling the amount of light emitted by the light sources.

US20080205080A1 (published 28 Aug. 2008) and US20090168420A1 (published 2 Jul. 2009) both disclose a design for a tiled backlight for LCD systems. This consists of an array of LGPs each of which has a light source attached to it that is arranged on the back of the LCD to achieve uniform illumination. Controlling the amount of light emitted by the individual light sources allows to locally control the brightness of the backlight in the area covered by the corresponding LGP. This arrangement allows for good local control but is very challenging in terms of mechanical mounting and stability.

US20090168455A1 (published 2 Jul. 2009) discloses a backlight for an LCD that consists of a single piece LGP and two or four arrays of LED light sources arranged on perpendicular edges or all four edges of the LGP respectively. In this single LGP backlight the LED light sources are arranged into blocks of N and M light sources for the long and short edges of the LGP. The emission of these LED blocks can be controlled individually. Like this the amount of light extracted from stripe shaped regions along the extension of the LGP can be controlled by the amount of light emitted by corresponding blocks of light sources. Completely switching off the light emission of one area of the LGP therefore entails dimming of two (respectively four) stripes along the LGP. This system is cost efficient and simple to produce but offers very limited local brightness control.

In summary, edge lit backlights with local control would be very beneficial to LCD devices as they would allow for very thin, light weight systems that offer enhanced contrast ratios and energy efficiencies. To date no system has been proposed or demonstrated that would incorporate good local control as well as thin and light weight design.

### SUMMARY OF INVENTION

A first aspect of the invention provides a backlight for a display, the backlight comprising: a light guide plate having opposing first and second major surfaces and being at least partly tessellated by first and second regions having one or more first light extraction features and one or more light extraction features, respectively; and one or more first light sources and one or more second light sources, the first light source(s) being independently controllable from the second light source(s), the first light source(s) and the second light sources being arranged to direct light into the plate such that the light propagates in first and second directions, respectively, parallel to the first major surface, the or each of the first features being arranged to direct the light travelling in the first direction from the first source or a respective one of the first sources out of the first major surface and to pass within the light guide plate the light travelling in the second direction, and the or each of the second features being arranged to direct the light travelling in the second direction from the second source or a respective one of the second sources out of the first major surface and to pass within the light guide plate the light travelling in the first direction.

As is well-known, saying that a shape “tessellates the plane” means that a collection of the shapes can be put together to fill the plane with no overlaps and with no gaps between shapes. Thus, the feature that the light guide plate is “at least partly tessellated” by the first and second regions means that one or more of the first regions and one or more of the second regions can be put together to fill part or all of a major surface of the light guide plate. In the embodiment of FIGS. 3a to 3f, for example, the entire surface of the light guide plate is tessellated by the first and second regions, whereas in the embodiment of FIG. 5 only part of the surface of the light guide plate is tessellated by the first and second regions, as the first and second regions do not extend into the sub-areas 15b of the light guide plate of FIG. 5. In general, the term “partly tessellated” contemplates that one or more sub-areas of the light guide plate are tessellated by the first and second regions.

The first region or at least one of the first regions may be arranged to receive the light travelling in the first direction through the second-region or at least one of the second regions.

The backlight may comprise a plurality of the first regions and a plurality of the second regions, at least one of the second regions being arranged to receive the light travelling in the second direction through at least one of the first regions.

The first and second directions may be substantially perpendicular to each other.

The first and second features may comprise surface relief features in at least one of the first and second major surfaces.

The first and second features may comprise elongate surface relief features extending perpendicular to the first and second directions, respectively.

The first and second surface relief features may comprise corrugations.

The corrugations may have cross-sectional shapes compromising at least one of triangular, trapezoidal, elliptical, parabolic and circular.

At least one of the size, spacing and shape of the corrugations may vary across the plate.

At least one of the size, spacing and shape of the corrugations may vary across each of at least some of the first and second regions.

The backlight may comprise further non-elongate light extraction features disposed in at least one of the first and second major surfaces of each of the first and second regions.

The first and second regions may be of the same shape and size.

The first and second regions may be rectangular and the plate may be rectangular.

Each of the first regions may be adjacent at least one second region.

The first and second regions may be arranged as alternating groups, respectively, each of which comprises at least one region.

The plate may have at least one edge surface and at least some of the light sources may be arranged to direct light into respective portions of the at least one edge surface.

At least some of the light sources may be arranged to direct light into respective ones of the first and second regions through edge portions of the second major surfaces thereof.

At least some of the light sources may be arranged to direct light into respective ones of the first and second regions through inclined surfaces at the edges thereof.

At least some of the light sources may be arranged to direct light into respective ones of the first and second regions through edge portions thereof extending out of the plane of the second major surface.

All of the light sources may be arranged to direct light into respective portions of the at least one edge surface.

Each portion of the at least one edge surface may comprise an edge surface of one of the first and second regions.

Each of the light sources may comprise at least one light emitter.

The first and second regions may fully tessellate the plate.

A backlight may comprises a first backlight as defined above and a second backlight as defined above disposed so that the first major surface of the plate of the second backlight faces the second major surface of the plate of the first backlight.

The plates of the first and second backlights may be congruent.

The first and second backlights may comprise third regions without light extraction features, the third regions of the first backlight are congruent with the first and second regions of the second backlight, and the third regions of the second backlight are congruent with the first and second regions of the first backlight.

The backlight may comprise a controller arranged to permit control of at least some of the first light sources independent from at least some of the second light sources. For example, the controller may control all the first light sources together, the controller may control all the second light sources together, but the controller may control the first light sources independently from the second light sources.

Alternatively, the first light sources may be grouped into two or more blocks that are controllable independently from one another and from the second light sources, and/or the second light sources may be grouped into two or more blocks that are controllable independently from one another and from the first light sources. Alternatively, it is in principle possible for each of the first light sources to be controllable independently from every other first light source and from the second light sources, and/or for each of the second light sources to be controllable independently from every other second light source and from the second light sources.

A second aspect of the invention provides a display comprising a backlight of the first aspect disposed behind a spatial light modular.

The spatial light modulator may comprise a liquid crystal device.

An embodiment of the invention relates to an LCD device. The LCD device comprises an LCD panel, a number of sheets of different optical materials, a backlight, an electrical arrangement to provide electronic control of the LCD and the backlight as well as a mechanical assembly to hold the individual parts in place. The backlight used with the LCD device is an illumination assembly that illuminates the LCD panel from the back, such as an edge lit backlight that provides the possibility of local control of the illumination of the LCD panel.

An example of a backlight in accordance with the current invention comprises at least one LGP with at least two light sources arranged on at least two light input sides of the LGP. The LGP is virtually divided into at least two sub-areas that achieve a tessellation of the area of the LGP. The LGP is provided with a pattern of corrugations on at least one of the top major surface and the bottom major surface of the LGP. The pattern of corrugations on at least one of the top major surface and the bottom major surface of the LGP coincides with the virtual tessellation of the LGP in a way such that corrugation patterns on adjacent sub-areas of the tessellation are essentially independent from each other and their orientations may not be parallel.

The light sources belonging to such a backlight may be arranged into blocks where a block of light sources consists of at least one light source that is arranged on at least one of the input sides of the LGP. Each block of light sources is correlated with exactly one of the sub-areas of the tessellation of the LGP. The correlation between each block of light sources and the corresponding sub-area of the tessellation of the LGP is such that the light emitted by this block of light sources is predominantly extracted in the corresponding sub-area.

The corrugations on the LGP have essentially two different functions depending on the relative orientation of the corrugations in a certain sub-area to the direction of propagation of the light passing through the area of the LGP that corresponds to said sub-area. For light that propagates essentially parallel to the direction of orientation of the corrugations in a sub-area of the LGP these corrugations will guide the light along their direction of orientation. Light that on the other hand propagates essentially perpendicular to the direction of orientation of the corrugations in a sub-area of the LGP will preferentially be extracted by the corrugations. Like this it is possible to unambiguously assign a specific block of light sources to each sub-area of the tessellation of the LGP in a way that the light emitted by one specific block of light sources will preferentially be extracted only in the corresponding sub-area.

An edge lit backlight with local control allows combining the light weights and thin depth dimensions of edge lit backlights with the local brightness control and low energy needs of a direct lit backlight. Providing light weight, thin form factor and local illumination control all in one device has been elusive so far. The use of an edge lit backlight allows designing very thin and light weight LCD devices. The distributed nature of illumination in an edge lit backlight makes it inherently difficult to control the illumination of the LCD panel locally. The use of sub-areas of the LGP that are equipped with specifically oriented corrugations and the specific assignment of one block of light sources for each sub-area of the tessellation of the LGP allows highly specific illumination control even in an edge lit backlight.

Similar kinds of groove arrangements on an LGP have earlier been disclosed in EP1016817A1, U.S. Pat. No. 6,773,126B1 and U.S. Pat. No. 6,144,480. However the first two of these arrangements aim to exploit the light extraction properties of the corrugations in order to achieve greater uniformity of light extraction over the area of the backlight. The latter of the three is not exploiting the macroscopic light deflection properties of the corrugations but is aiming to use microscopic diffraction of an optical wave at the corrugations that essentially form a grating for the optical wave. The present arrangement uses a very specific arrangement of corrugated sub-areas of the LGP in contrast to these earlier disclosures. This arrangement allows specifically assigning the light emitted by blocks of light sources to a sub-area of the LGP where this light will be extracted. In this way it is possible to control the light emitted by the backlight in a specific sub-area by controlling the light emitted by the corresponding block of light sources.

Another way of achieving local control in an edge lit backlight is to construct the backlight from physically separate small LGPs (US20080205080A1 and US20090168420A1). Each of the small LGPs is furnished with a separate light source. An arrangement like this is mechanically very difficult to realise and it needs a large number of light sources to achieve good local control. The present arrangement employs highly efficient light sources only around the circumference of one LGP. Furthermore it does not necessitate a complicated mechanical arrangement.

In US20090168455A1 an edge lit backlight was disclosed that allows for a certain degree of local brightness control without using corrugations. However in this disclosure each sub-area of the LGP is supplied with light by at least two light sources arranged along two perpendicular edges of the LGP. These two light sources are not exclusively illuminating one single sub-area and hence dimming the light sources for one sub-area affects multiple sub-areas of the LGP. In the present arrangement, each sub-area is exclusively associated with one block of light sources. Therefore decreasing the light from one block of light sources only affects the light extraction of one sub-area.

### BRIEF DESCRIPTION OF DRAWINGS

FIG. 1: Shows a schematic of an LCD with backlight that is able to provide local control (prior art).

FIGS. 2a, b: Show schematics of an edge lit backlight with a light source arrangement that provides local control (prior art).

FIG. 3a-f: Show schematics of different LCD backlights in accordance with specific embodiments of the current invention.

FIGS. 4a, b: Show schematics of an LCD backlight in accordance with a further embodiment of the current invention.

FIG. 5: Shows a schematic of an LCD backlight in accordance with a further embodiment of the current invention.

FIG. 6: Shows a schematic of the shape of the corrugations on one major surface of the LGP in accordance with the current invention.

FIG. 7: Shows a detailed depiction of the parameters governing the corrugations on the LGP.

FIG. 8: Shows a variation in the height of the corrugations in compliance with the current invention.

FIGS. 9a, b: Show two different kinds of variation of the angle of the corrugations in compliance with the current invention.

FIGS. 10a, b: Show different variations of the pitch and height of the corrugations in compliance with the current invention.

FIG. 11a-c: Show different shapes of corrugations in compliance with the current invention.

FIG. 12: Shows a section of an LGP in accordance with the current invention with volume scatterers dispersed in the corrugations.

FIGS. 13a, b: show sectional views of an LGP in accordance with the current invention with two different arrangements of surface scatterers to aid the light extraction.

FIGS. 14a, b: Show an additional embodiment of the current invention and an exemplary method of tessellation of said additional embodiment.

### DESCRIPTION OF EMBODIMENTS

Preferred embodiment of the invention will be described with reference to the drawings.

The invention provides a backlight for a display. The backlight comprises: a light guide plate (LGP) having opposing first and second major surfaces, and which is at least partly tessellated by first and second regions having first and second light extraction features, respectively. The backlight also has first and second independently controllable light sources arranged to direct light into the plate such that the light propagates in first and second directions, respectively, parallel to the first major surface of the LGP. The or each of the first features is arranged to direct the light travelling in the first direction from the first source or a respective one of the first sources out of the first major surface and to pass within the light guide plate the light travelling in the second direction, and the or each of the second features is arranged to direct the light travelling in the second direction from the second source or a respective one of the second sources out of the first major surface and to pass within the light guide plate the light travelling in the first direction.

Embodiments of the current invention contain an LGP that might be produced of any material conforming to the total internal reflection requirement given by the formula:

$${θ}_{TIR} = arcsin ( \frac{{n}_{air}}{{n}_{LGP}} )$$

(where nₐᵢᵣ denotes the refractive index of air, n_{LGP} denotes the refractive index of the LGP, and θ_{TIR} denotes the smallest angle of incidence at which total internal reflection occurs.) Furthermore said device contains an arrangement of light sources within the scope of the current invention. In addition such a device may contain a number of optical sheet materials arranged on either side of the LGP, an LCD which is illuminated by the backlight and a mechanical arrangement to house the device.

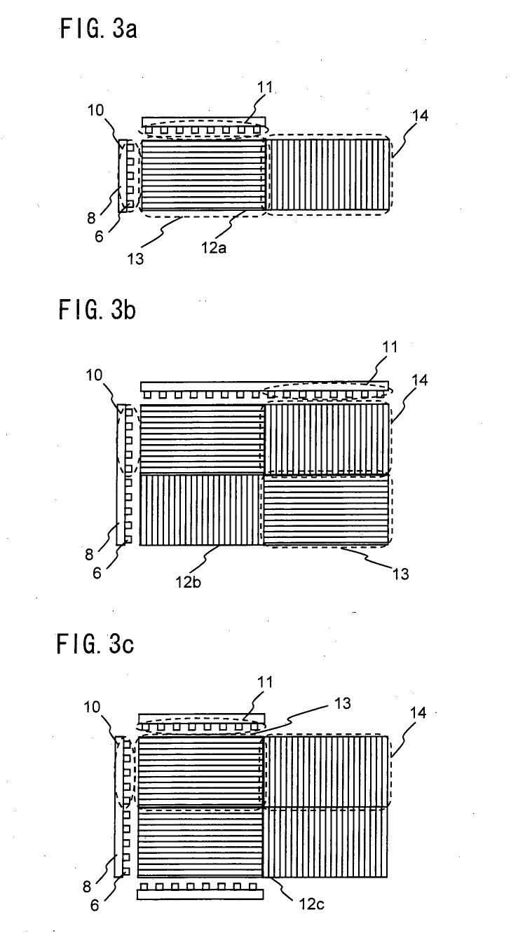

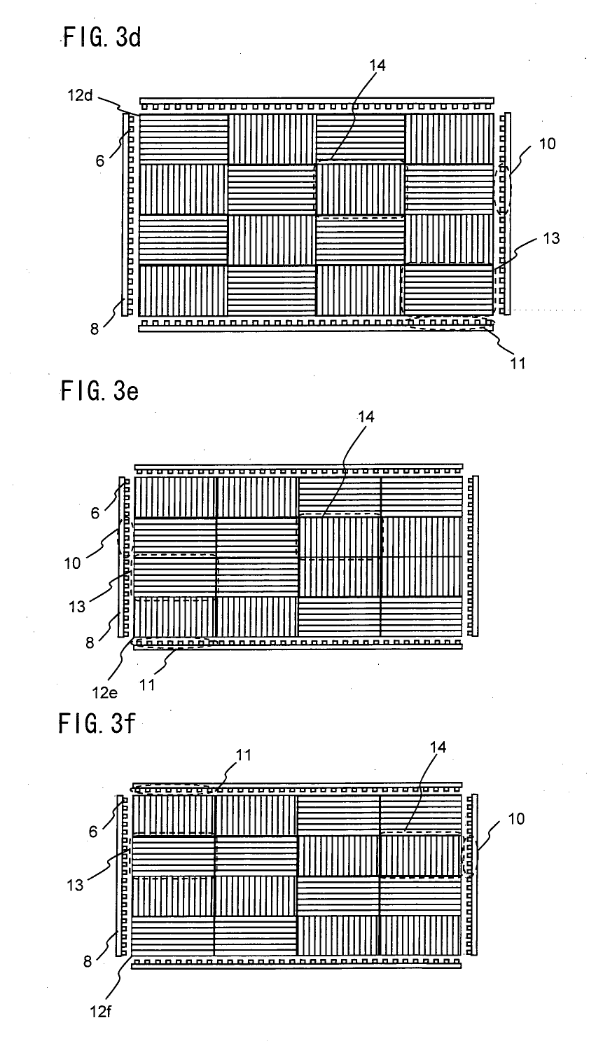

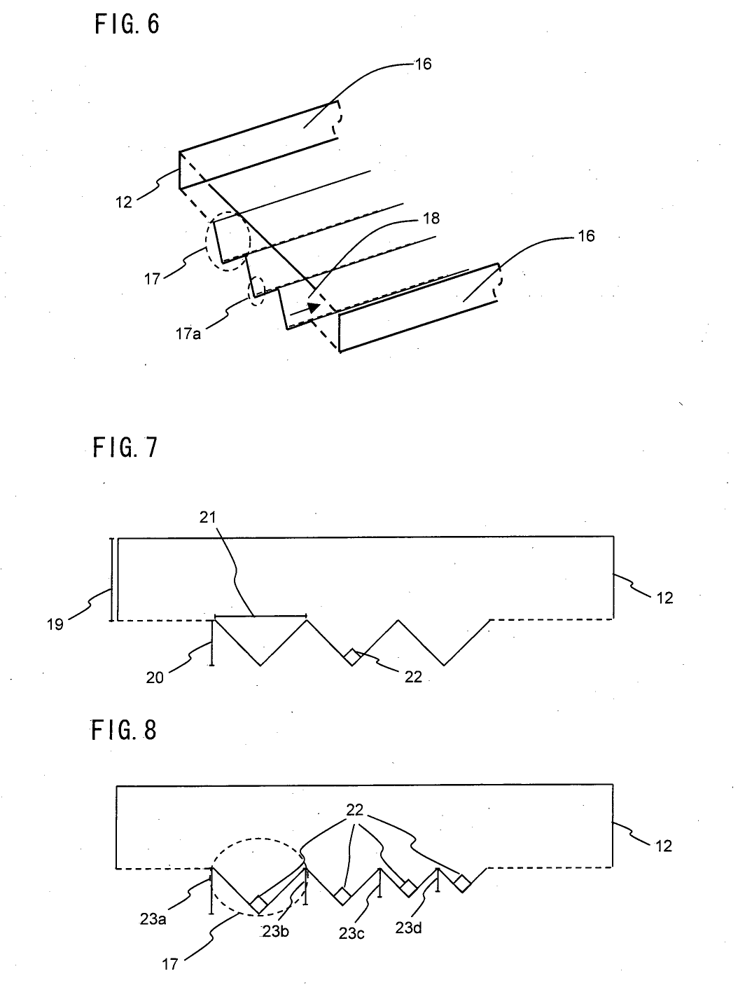

A first group of embodiments of the invention is described with reference to FIGS. 3a-e and FIGS. 6 to 13b. According to the first embodiment of the current invention FIG. 3a shows, in plan view from above, an LGP 12a together with two linear arrays 8 of light sources 6 arranged on two input edges of the LGP. A preferred embodiment of the light sources is light emitting diodes; however this invention is not limited to that and other types of light sources may be used such as, for example laser diodes. Moreover in many applications of a backlight of the invention it will be desired for the backlight to emit white light, and in such cases white light sources such as white light-emitting diodes may conveniently be used. Alternatively, a backlight that emits white light may also be implemented if the light sources 6 contain light sources that emit light in two or more different wavelength ranges—for example the light sources 6 may contain one or more light sources that emit red light, one or more light sources that emit green light and one or more light sources that emit blue light (or one or more light sources that emit each of cyan, magenta or yellow light) to thereby give an overall white light output. The use of light sources that emit in different wavelength ranges would make it possible to not only control the brightness of the backlight locally but also to control the colour of the backlight locally. It should be understood however that the invention is not limited to a backlight that emits white light and may also provide a backlight that emits monochromatic light.

The LGP has first and second major surfaces which are a front surface and a bottom surface. On one of its major surfaces the LGP has a pattern of light extraction features, in this example surface relief features, for example elongate surface relief features such as corrugations, provided on at least one major surface of the LGP. The corrugations are arranged in first and second regions, or sub-areas, 14, 13 for which the direction of orientation of the corrugations is essentially perpendicular to the direction of orientation of the corrugations of the adjacent sub-area. Thus, the corrugations in the first region 14 constitute first light extraction features, and the corrugations in the second region 13 constitute second light extraction features. The light sources 6 on the edges of the LGP 12a are arranged into a block 10 of first light sources and a block 11 of second light sources. The light emitted by the block of first light sources 10 propagates in a first direction and is extracted in the first sub-area 14 and similarly the light emitted by the block 11 of second light sources propagates in a second direction and is extracted in the second sub-area 13. Moreover, light from the block 10 of first light sources is not extracted (or is not extracted to any significant extent) in the second sub-area 13 and light from the block 11 of second light sources is not extracted (or is not extracted to any significant extent) in the first sub-area 14.

The block of first light sources 10 is controllable independently from the block of second light sources 11, using a suitable controller (not shown) that is arranged to permit control of the first light sources independently from the second light sources, and this allows the light output from the sub-area 13 to be controlled independently from the light output from the sub-area 14. (Although only one block 10 of first light sources and one block of second light sources 11 is shown in FIG. 3a, the invention is not limited to this and it would be possible to provide two or more blocks 10 of first light sources and two or more blocks 11 of second light sources.)

FIG. 3a illustrates the general principle of the invention, namely that light from the block 10 of first light sources propagates in a first direction in the LGP and is extracted from the LGP by the one or more first light extraction features (in this example corrugations) in a first sub area 14, but is not extracted (at least to any significant extent) by the one or more light extraction features in the second sub-area 13. Similarly, light from the block 11 of second light sources propagates in the LGP in a second direction (which is crossed with, and optionally is substantially perpendicular to the first direction) and is extracted from the LGP by the second light extraction features (in this example corrugations) in a second sub area 13 but is not extracted (at least to any significant extent) by the light extraction features in the first sub-area 14. It is therefore possible to vary the intensity of light extracted from the first sub-area 14 independently of the intensity of light extracted from the second sub-area 13, since the block of first light sources 10 is controllable independently from the block of second light sources 11.

The embodiment of FIG. 3a may be varied without departing from the concept of the invention, for example in particular arrangement of the first and second sub-areas 14, 13 and the blocks 10, 11 of first and second light sources. Some possible variations are shown in FIGS. 3b to 3f by way of example—to avoid repetition, detailed description of features of these embodiments that are the same as for the embodiment of FIG. 3a will not be repeated.

FIGS. 3b, 3c depict a second and third embodiment of backlight in, accordance with the current invention. A backlight is shown that comprises, similar to the previous embodiment, an LGP that is provided with light extraction features, in this example in this example surface relief features, for example elongate surface relief features such as corrugations, on at least one of its major surfaces. The corrugations are arranged into four sub-areas, two first sub-areas (or regions) 14 and two second sub-areas (or regions)-13. The direction of orientation of the corrugations on each of the sub-areas 13 is essentially perpendicular to the direction of orientation of corrugations in at least one adjacent sub-area 14. The backlight has at least two linear arrays 8 of light sources 6 that are arranged on at least two perpendicular input faces of the LGP 12b, c. The light sources 6 are arranged into one or more blocks 10 of first light sources and one or more blocks 11 of second light sources.

At least some of the first light sources can be controlled independently from at least some of the second light sources by a suitable controller (not shown). For example, FIG. 3b shows the light sources along one edge of the LGP arranged into two blocks 10 of first light sources and the light sources along another edge of the LGP arranged into two blocks 11 of second light sources—the controller may be arranged to control each block of first light sources independently from one another and from the second light sources, and/or to control each block of second light sources independently from one another and from the first light sources.

In FIG. 3d a further embodiment of a backlight in accordance with the current invention is shown. The LGP 12d has first and second major surfaces (eg a front face and bottom face) on at least one of which it has a pattern of light extraction features, in this example surface relief features, for example elongate surface relief features such as corrugations.

The corrugations are arranged in four columns and four rows to give a total of 16 sub-areas, comprising 8 first sub-areas (or regions) 14 and 8 second sub-areas (or regions) 13. The direction of orientation of the corrugations of one sub-area is essentially perpendicular to the direction of orientation of the corrugations of at least one adjacent sub-area. The backlight in FIG. 3d has four linear arrays 8 of light sources 6. These light sources are arranged into blocks 10 of first light sources and blocks 11 of second light sources, such that at least some of the first light sources can be controlled independently from at least some of the second light sources by a suitable controller (not shown). Preferably the controller is arranged to control each block of first light sources independently from one another and from the second light sources, and/or to control each block of second light sources independently from one another and from the first light sources. Each of these blocks of light sources illuminates exactly along one column, or one row of sub-areas of the LGP. The light from each individual block is extracted in exactly one corresponding sub-area of the LGP. The sub-area in which the light is extracted is the first sub-area along the direction of propagation of the light that features a direction of orientation of the corrugations that is essentially perpendicular to the direction of the propagation of the light. In FIGS. 3e, 3f we depict two more embodiments of a backlight in accordance with the current invention, each having an LGP 12e, 12f. The embodiments shown in FIGS. 3e, 3f are essentially the same as in FIG. 3d apart from the specific arrangement of the directions of orientation of the grooves in the tessellation of the LGP.

FIG. 6 is a partial perspective view of an LGP 12 of a backlight according to an embodiment of the invention, and shows schematically the corrugations on one of the major surfaces of the LGP 12. The LGP 12 may be an LGP in accordance with any of the embodiments of the current invention. The LGP 12 possesses at least two parallel side faces 16 which are used to input light into the LGP. The corrugations 17 in at least one individual sub area of the LGP 12 extend in a direction 18 that is essentially parallel to the LGP's side faces 16. The direction 18 of the corrugations is the same as the direction of their apexes. The direction of the apexes of the corrugations may change over the extension of the respective sub-area. The preferred embodiment is straight and parallel corrugations but this invention is not limited to that. The corrugations are defined by a set of parameters which are explained in FIG. 7, which is a sectional view through the LGP shown in FIG. 6. The LGP 12 has a height dimension 19. The corrugations in each individual sub-area have a height 20, a width 21, an apex angle 22 as well as a number N (where N is the number of corrugations in a sub-area). The values of the parameters defining the corrugations in one sub-area of the LGP 12 need not be the same as for any other sub-area of the LGP 12. The corrugations have a triangular cross-sectional shape.

The values of the parameters 20, 21, 22 for one corrugation 17 in one sub-area of the LGP 12 need not be the same for any other corrugation 17 of the same sub-area of the LGP 12. FIG. 8 show a schematic cross section through one sub-area of the LGP 12 in another embodiment of the invention. The corrugations 17 of this sub-area have a height 23a-d that changes over the extent of the sub-area perpendicular to the direction of the corrugations 17. The height of each corrugation may, alternatively or additionally, change along the length of the corrugation. The apex angle 22 of the corrugation may remain constant over the whole sub-area of the LGP.

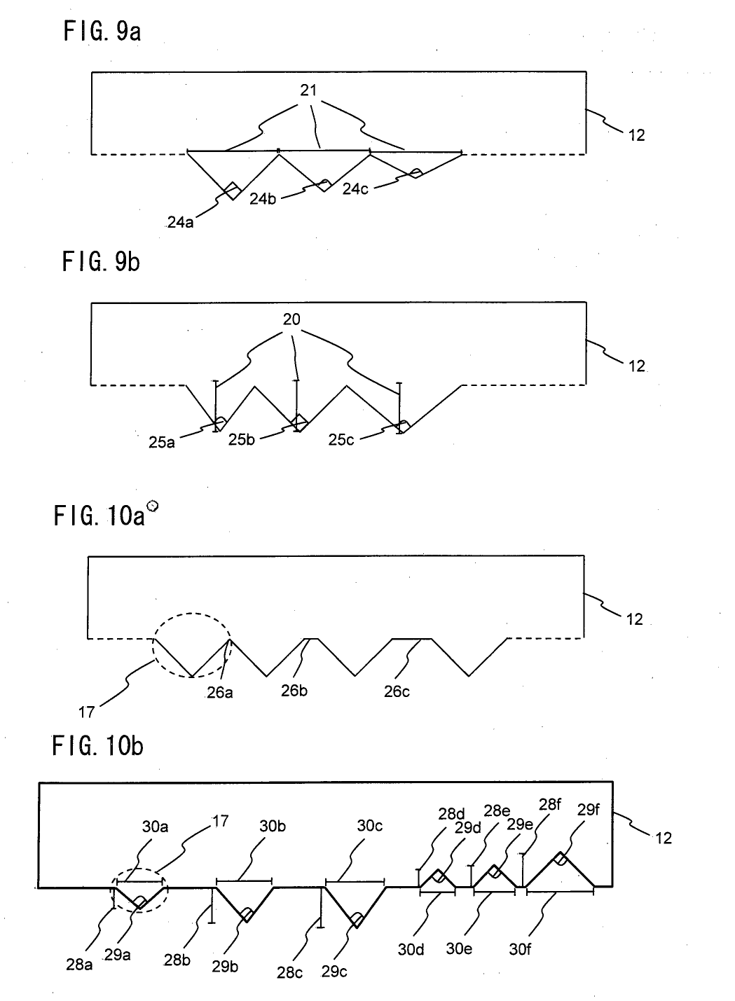

FIGS. 9a, 9b each show a schematic cross section through one sub-area of the LGP 12 according to further embodiments of the invention. The corrugations in FIG. 9a are all part of the same sub-area of the LGP 12. These corrugations may all have the same value for their width 21. Over the extent (perpendicular to the direction of the corrugations 17) of the sub-area the value for the apex angle changes 24a-c. As a result of this the value for the height of the corrugations may have to change in a way so that the value for their width 21 may remain constant over the whole sub-area. The corrugations shown in FIG. 9b may have the same value for their height 20 over the whole width of the sub-area. The value for the apex angle of the corrugations changes over the sub-area 25a-c. As a result the value of the width of the corrugations may have to change in a way so that the value of the height of the corrugations may remain constant.

FIGS. 10a, 10b each show a schematic cross section through one sub-area of the LGP 12 according to further embodiments of the invention. The corrugations 17 in FIG. 10a all belong to the same sub-area of the LGP 12. The corrugations 17 are characterised by a certain distance between neighbouring corrugations on the same sub-area. The value for this distance can change 26a-c over the extent (perpendicular to the direction of the corrugations 17) of the sub-area. The distances between corrugations on different sub-areas of the LGP may have different values. The corrugations 17 in FIG. 10b all belong to the same sub-area of the LGP 12. The corrugations 17 in FIG. 10b possess a height 28a-f and an apex angle 29a-f that both may change over the extent (perpendicular to the direction of the corrugations 17) of the sub-area. The height of the corrugations 17 can have positive values 28a-c, and then the corrugations 17 protrude towards the outside of the LGP 12, as well as negative values 28d-f, and then the corrugations 17 extend towards the inside of the LGP 12. The widths 30a-f of the corrugations 17 in FIG. 10b are determined by their heights 28a-f and apex angles 29a-f.

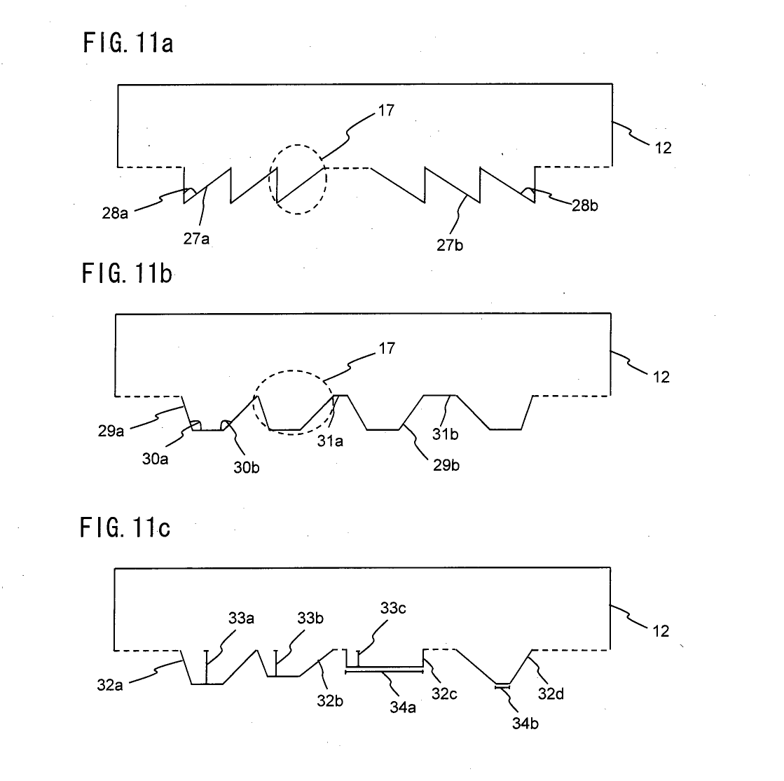

FIGS. 11a-11c each show a schematic cross section through one sub-area of an LGP 12 according to further embodiments of the invention. The corrugations shown in FIGS. 11a-c may be part of the same sub-area of the LGP but need not be. The corrugations 17 in FIG. 11a essentially have an asymmetric triangular profile. The orientation of this triangular profile can change 27a, b within one sub-area or between sub-areas of the LGP 12. The apex angles 28a, b can change within one sub-area or between different sub-areas of the LGP 12. The corrugations 17 in FIG. 11b have an essentially quadrangular profile. In the example shown in FIG. 11b, the corrugations have a trapezoidal cross-sectional shape. This profile 29a, b can change within one sub-area or between different sub-areas of the LGP 12. Instead of a single apex angle 22 for each corrugation of triangular profile the corrugations of quadrangular profile are characterised by two angles 30a, b. These two angles can be different from one another and they may change for corrugations within one sub-area or between sub-areas of the LGP. The corrugations within one sub-area of the LGP can be separated from each other by a certain distance. The value of this distance 31a, b can change within one sub-area or between sub-areas of the LGP 12. In FIG. 11c different possible variations of the corrugations 17 with quadrangular 32a-d profile are shown. Along with their angles 30a, b the corrugations 32a-d are characterised by a height 33a-c and a width 34a-b. The value for these parameters can change for corrugations within one sub-area or between different sub-areas of the LGP 12.

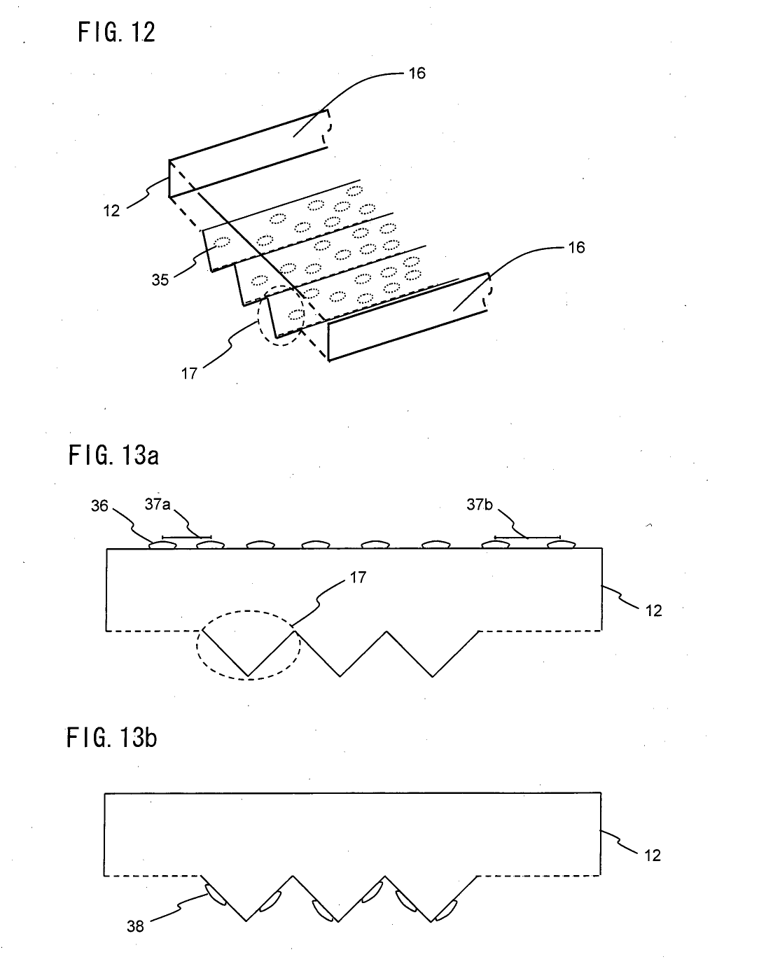

FIG. 12 shows schematic perspective view of a sub-area of the LGP 12 according to a further embodiment of the invention. The corrugations 17 of this sub-area contain bodies 35 that modulate the propagation direction of light. These bodies are provided within, and are dispersed over, the volume of the LGP 12. The number density of these bodies may change over one sub-area or between different sub-areas of the LGP 12.

FIGS. 13a-b each show a schematic cross section through one sub-area of the LGP 12 according to further embodiments of the invention. The corrugations 17 shown in FIGS. 13a-b may be part of the same sub-area of the LGP but need not be. The surface of the LGP 12 that is opposite to the surface baring the corrugations in FIG. 13a is equipped with bodies 36 that modulate the direction of propagation of light interacting with them. These bodies 36 are characterised by a certain distance 37a-b between adjacent bodies. This distance may change within one sub-area or between different sub-areas of the LGP 12. Similarly the LGP 12 in FIG. 13b is supplied with bodies 38 that modulate the direction of propagation of light on the surface baring the corrugations of the LGP 12.

It should be understood that FIGS. 6 to 13b only show examples of possible corrugations 17 for backlights of the invention, and that the invention is not limited to these specific corrugations. For example, corrugations having triangular and trapezoidal cross-sectional shapes have been illustrated but other cross-sectional shapes may be used. Examples of such other shapes include elliptical, parabolic and circular.

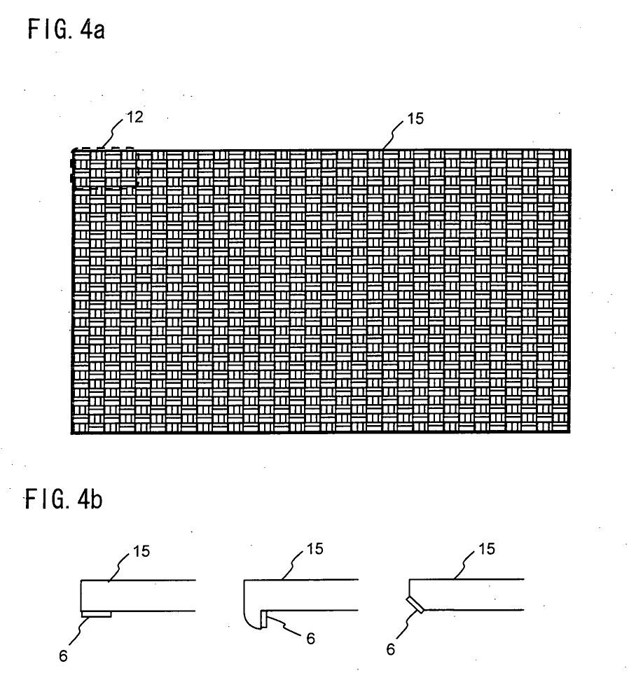

Another embodiment of a backlight in accordance with the current invention is shown in FIGS. 4a, 4b. In FIG. 4a a schematic plan view of an LGP 15 is shown. As in other embodiments, the LGP 15 has first and second major surfaces and is provided with light extraction features, in this example surface relief features, for example elongate surface relief features such as corrugations, on at least one of its major surfaces. This LGP 15 is virtually tessellated into 16*M sub-areas. In the specific embodiment of FIG. 4a 8 sub-areas fit along each side of the LGP so that M=8×8=64, but the invention is not limited to this. A set of 16 sub-areas 12 that form a virtual array of four by four sub-areas is essentially as described for previous embodiments of the current invention, for example as for the embodiment of FIG. 3d. The backlight in FIG. 4a has a number of light sources that are positioned below the LGP 15.

Although not shown explicitly in FIG. 4a, these light sources are arranged into blocks of first light sources and blocks of second light sources, such that at least some of the first light sources can be controlled independently from at least some of the second light sources by a suitable controller (not shown). Preferably the controller is arranged to control each block of first light sources independently from one another and from the second light sources, and/or to control each block of second light sources independently from one another and from the first light sources. Preferably each of these blocks of light sources illuminates exactly along one column or one row of sub-areas of the LGP.

In FIG. 4b three alternative possible cross sections through part of the LGP 15 are shown, each alternative, cross-section relating to a different way of inputting light from a light source 6 positioned below the LGP 15. A backlight in accordance with this embodiment of the invention may make use of any of the depicted ways of inputting light but is not limited to that.

For example, some or all of the first and second light sources may be arranged to direct light into the first and second regions, respectively, through edge portions of the LGP 15 that extending out of the plane of the bottom surface of the LGP (that is, the major surface of the LGP opposite to the major surface from which light is extracted). This is shown in the central view of FIG. 4b.

Alternatively, some or all of the first and second light sources may be arranged to direct light into the first and second regions, respectively, through inclined surfaces at the edges of the LGP. This is shown in the right view of FIG. 4b.

Alternatively, some or all of the first and second light sources may be arranged to direct light into the first and second regions, respectively, through edge portions of the bottom surface of the LGP.

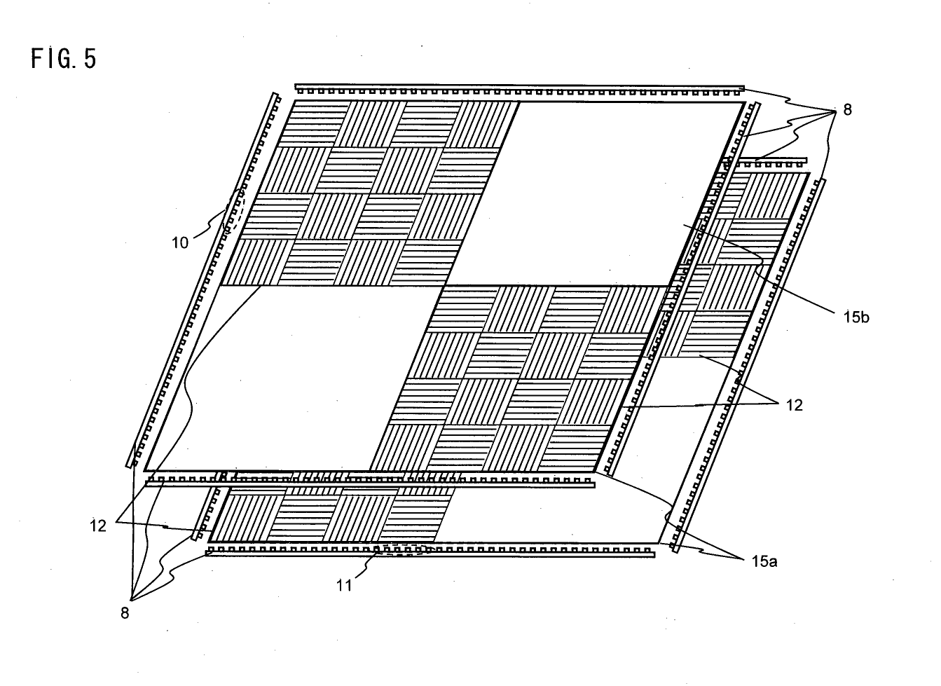

A further embodiment of the current invention is shown in FIG. 5. A backlight in accordance with this embodiment of the current invention comprise a first backlight and a second backlight disposed so that the first major surface of the LGP of: the second backlight faces the second major surface of the LGP of the first backlight. The first backlight and the second backlight is each a backlight of the invention, and may be one of the backlights described above. Thus, the backlight of this embodiment has two LGPs 15a. Each LGP 15a has first and second major surfaces and is provided with light extraction features, in this example surface relief features, for example elongate surface relief features such as corrugations, on at least one of its major surfaces. One of the LGPs 15a of the current embodiment is positioned below the second LGP 15a of the current embodiment and it is positioned congruent with the second LGP 15a. The LGP 15a has a virtual tessellation of 34 sub-areas. Two sub-tessellations 12 of this tessellation each consist of 16 of the 34 sub-areas of the LGP 15a. These sub-tessellations 12 of the LGP 15a are essentially as described above, for example for one of the embodiments of the current invention described in FIGS. 3d-f. The remaining two sub-areas 15b of the LGPs 15a are manufactured in a way to prevent light extraction through the major surfaces of these sub-areas 15b of the LGPs 15a and thus form third regions without light extraction features. The two LGPs 15a are arranged in a way so that the sub-tessellations 12 of the first LGP 15a are positioned above the sub-areas 15b of the second LGP 15a, and so that the sub-tessellations 12 of the second LGP 15a are positioned below the sub-areas 15b of the first LGP 15a. The backlight of FIG. 5 in accordance with the current invention has eight linear arrays 8 of light sources 6. Each of the LGPs 15a of the current embodiment has four of the total of eight linear arrays 8 of light sources 6. The light sources 6 are arranged in blocks 10 of first light sources and blocks 11 of second light sources along the perpendicular input sides of the LGP 15a. These light sources are arranged such that at least some of the first light sources can be controlled independently from at least some of the second light sources by a suitable controller (not shown). Preferably the controller is arranged to control each block of first light sources independently from one another and from the second light sources, and/or to control each block of second light sources independently from one another and from the first light sources. Each of these blocks of light sources illuminates exactly along one column or one row of sub-areas of the sub-tessellations 12 of the LGP.

In an alternative embodiment of the current invention light guiding features may be provided in the sub-areas 15b so that light from the light sources at one or two of the edges of the sub-areas 15b is guided through the sub-areas 15b, to the sub-tessellations 12. The light guiding features may be, or may include, surface features but are arranged to provide little or substantially no extraction of light through the major surfaces of the sub-areas 15b.

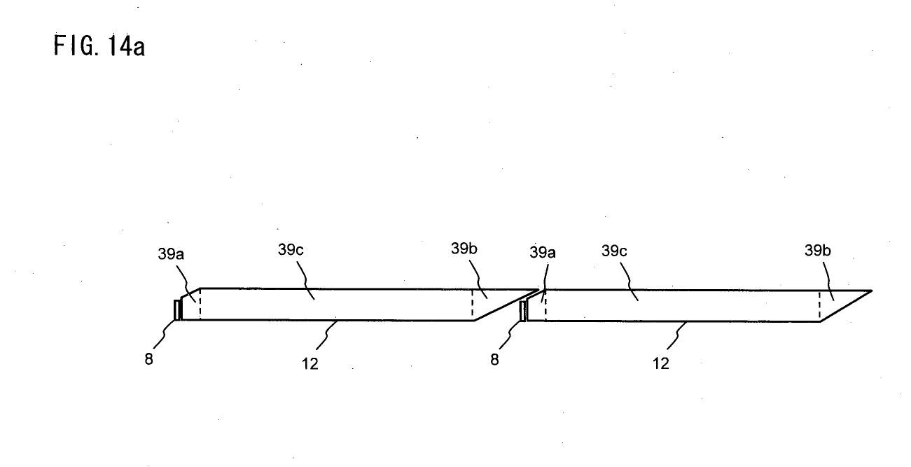

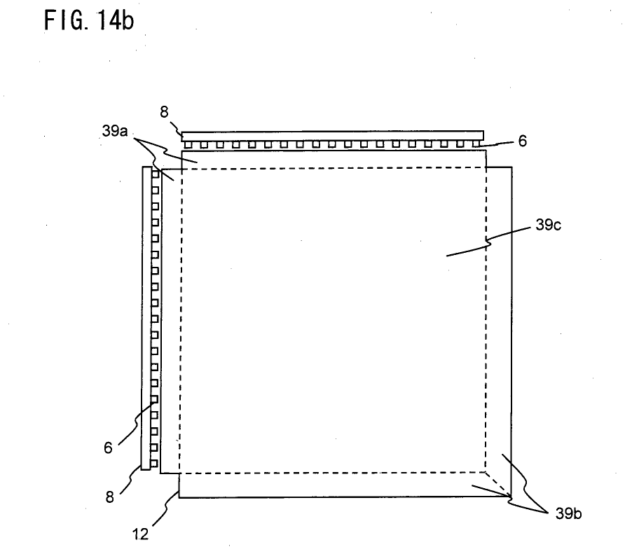

In an alternative embodiment of the current invention the LGP 12 has segments 39a, 39b and 39c as shown in FIGS. 14a and which is a schematic sectional view of a backlight of this embodiment. The segments 39a are manufactured in such a way that no light is extracted from these segments. The segments 39b and 39c of the LGP are structured in accordance with the current invention, for example as described in any one of FIGS. 3a-3f, and the corrugations provided on the LGP may for example have the form shown in any one of FIGS. 6-13b. Light passing through said segments 39b and 39c is extracted from said segments. Furthermore segments 39a and 39b are structured in a way as to make it possible to seamlessly arrange individual LGPs 12 in a two dimensional array. Segments 39b of LGPs 12 arranged in such a two dimensional array are covering at least one adjacent LGP 12 in a way as to cover a segment 39a and a linear array 8 of light sources 6 of said adjacent LGP 12. In FIG. 14b an exemplary top view of an LGP 12 allowing for such two dimensional arrangement is shown.

An embodiment of the current invention described here may include optical films to manipulate the light in a way as to achieve uniformity or improve efficiency.

The preferred embodiment of the current invention makes use of a rectangular tessellation of the LGP but is not limited to that. For example any regular or irregular tessellation and corresponding patterning of corrugations on part of at least one major surface of the LGP may be covered by this patent including triangular, rectangular, hexagonal and octagonal.

In the embodiments described above, the light sources 6 are arranged in first blocks 10 or second blocks 11, with each first block of light sources being controllable independently of other first blocks of light sources and being controllable independently of second blocks of light sources and with each second block of light sources being controllable independently of other second blocks of light sources and being controllable independently of first blocks of light sources. The invention is not however limited to this. For example it would be possible to control the intensity of light emitted by a region of the backlight by arranging the controller such that it can turn ON only a proportion (for example ½ or ¼) of the light sources in a block of first light sources or in a block of second light sources. In principle, the controller could be arranged to control each first light source independently of other first light sources and independently of the second light sources, and/or to control each second light source independently of other second light sources and independently of the first light sources.

In a general embodiment, a backlight is provided for illuminating an at least partially transmissive display. The backlight includes blocks of light sources that can be individually controlled. A light guide receives the light from an edge surface and guides the light by total internal reflection. Groove structures which are located on at least one of the major surfaces of the light guide permit either directional guiding or extraction of the light.

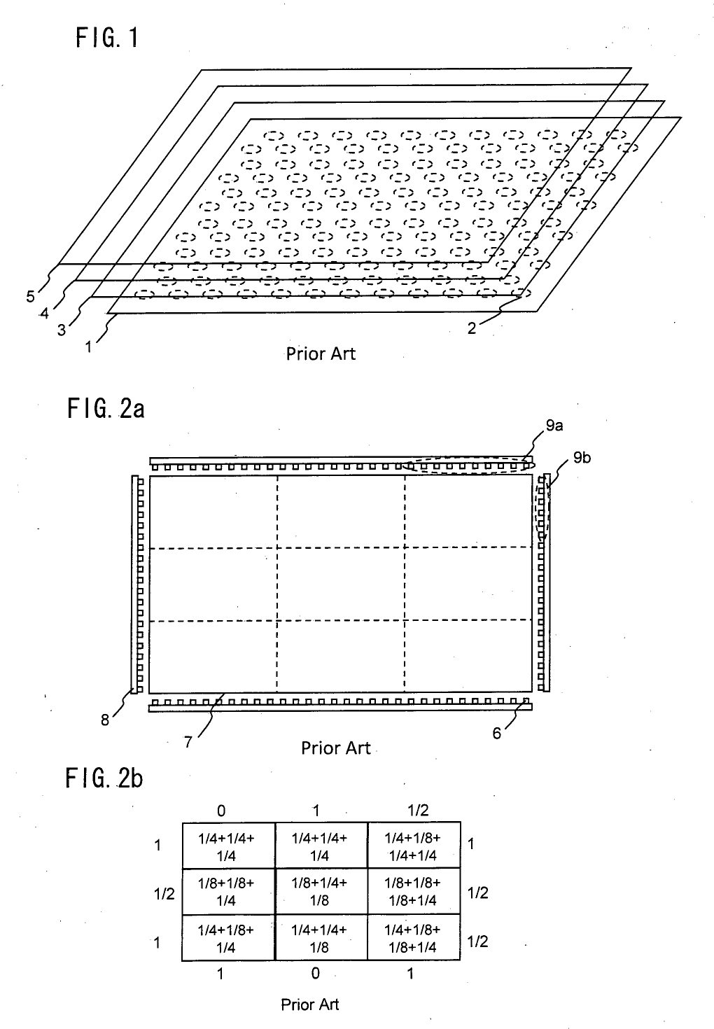

A backlight of the invention may be used as a backlight of a display, by arranging the backlight such that light extracted from the backlight is directed towards a spatial light modulator that may be controlled to modulate the light from the backlight so that the spatial light modulator and the backlight together constitute a display. As an example, a backlight of the invention may be used as a backlight of a display in which a liquid crystal panel acts as the spatial light modulator of the display—so, for example, a backlight of the invention may be used as a backlight in a display of the general type shown in FIG. 1.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

1. A backlight for a display, comprising: a light guide plate having opposing first and second major surfaces and being at least partly tessellated by first and second regions having one or more first light extraction features and one or more second light extraction features, respectively; and one or more first light sources and one or more second light sources, the first light source(s) being independently controllable from the second light source(s), each block of the first light source(s) being independently controllable from one another, and each block of the second light source(s) being independently controllable from one another, the first light source(s) and the second light sources being arranged to direct light into the plate such that the light propagates in first and second directions, respectively, parallel to the first major surface, the or each of the first features being arranged to direct the light travelling in the first direction from the first source or a respective one of the first sources out of the first major surface and to pass within the light guide plate the light travelling in the second direction, and the or each of the second features being arranged to direct the light travelling in the second direction from the second source or a respective one of the second sources out of the first major surface and to pass within the light guide plate the light travelling in the first direction.

2. A backlight as claimed in claim 1, in which the first region or at least one of the first regions is arranged to receive the light travelling in the first direction through the second-region or at least one of the second regions.

3. A backlight as claimed in claim 2, comprising a plurality of the first regions and a plurality of the second regions, at least one of the second regions being arranged to receive the light travelling in the second direction through at least one of the first regions.

4. A backlight as claimed in claim 1, in which the first and second directions are substantially perpendicular to each other.

5. A backlight as claimed in claim 1, in which the first and second features comprise surface relief features in at least one of the first and second major surfaces.

6. A backlight as claimed in claim 5, in which the first and second features comprise elongate surface relief features extending perpendicular to the first and second directions, respectively.

7. A backlight as claimed in claim 5 in which the first and second surface relief features comprise corrugations.

8. A backlight as claimed in claim 7, in which the corrugations have cross-sectional shapes compromising at least one of triangular, trapezoidal, elliptical, parabolic and circular.

9. A backlight as claimed in claim 7, in which at least one of the size, spacing and shape of the corrugations varies across the plate.

10. A backlight as claimed in claim 9, in which at least one of the size, spacing and shape of the corrugations varies across each of at least some of the first and second regions.

11. A backlight as claimed in claim 6, comprising further non-elongate light extraction features disposed in at least one of the first and second major surfaces of each of the first and second regions.

12. A backlight as claimed in claim 1, in which the first and second regions are of the same shape and size.

13. A backlight as claimed in claim 12, in which the first and second regions are rectangular and the plate is rectangular.

14. A backlight as claimed in claim 1, in which each of the first regions is adjacent at least one second region.

15. A backlight as claimed in claim 14, in which the first and second regions are arranged as alternating groups, respectively, each of which comprises at least one region.

16. A backlight as claimed in claim 1, in which the plate has at least one edge surface and at least some of the first and second light sources are arranged to direct light into respective portions of the at least one edge surface.

17. A backlight as claimed in claim 1, in which at least some of the first and second light sources are arranged to direct light into respective ones of the first and second regions through edge portions of the second major surfaces thereof.

18. A backlight as claimed in claim 1, in which at least some of the first and second light sources are arranged to direct light into respective ones of the first and second regions through inclined surfaces at the edges thereof.

19. A backlight as claimed in claim 1, in which at least some of the first and second light sources are arranged to direct light into respective ones of the first and second regions through edge portions thereof, the edge portions extending out of the plane of the second major surface.

20. A backlight as claimed in claim 16, in which all of the first and second light sources are arranged to direct light into respective portions of the at least one edge surface.

21. A backlight as claimed in claim 16, in which each portion of the at least one edge surface comprises an edge surface of one of the first and second regions.

22. A backlight as claimed in claim 1, in which each of the first and second light sources comprises at least one light emitter.

23. A backlight as claimed in claim 1, in which the first and second regions fully tessellate the plate.

24. A backlight comprising a first backlight as claimed in claim 1 and a second backlight as claimed in claim 1 disposed so that the first major surface of the plate of the second backlight faces the second major surface of the plate of the first backlight.

25. A backlight as claimed in claim 24, in which the plates of the first and second backlights are congruent.

26. A backlight as claimed in claim 25, in which the first and second backlights comprise third regions without light extraction features, the third regions of the first backlight are congruent with the first and second regions of the second backlight, and the third regions of the second backlight are congruent with the first and second regions of the first backlight.

27. A backlight as claimed in claim 1, comprising a controller arranged to permit control of at least some of the first light sources independent from at least some of the second light sources.

28. A display comprising a backlight as claimed in claim 1 disposed behind a spatial light modular.

29. A display as claimed in claim 28, in which the modulator comprises a liquid crystal device.

30. A backlight as claimed in claim 1, wherein
the first light source(s) are independently controllable from one another and from the second light source(s), and
the second light source(s) are independently controllable from one another and from the first light source(s).
